(19) United States
(12) Patent Application Publication
(10) Pub. No.: US 2025/0252675 A1
(43) Pub. Date: Aug. 7, 2025

(54) METHOD TO USE 360 DEGREE CAMERAS

(71) Applicant: Be More Colorful, LLC, Fargo, ND (US)

(72) Inventors: Matthew Chaussee, Fargo, ND (US); Katie Chaussee, Fargo, ND (US)

(73) Assignee: Be More Colorful, LLC, Fargo, ND (US)

(21) Appl. No.: 19/190,554

(22) Filed: Apr. 25, 2025

Related U.S. Application Data
(63) Continuation-in-part of application No. 17/854,223, filed on Jun. 30, 2022, now Pat. No. 12,316,973.
(60) Provisional application No. 63/289,090, filed on Dec. 13, 2021.

(51) Int. Cl. G06T 19/00; G06T 15/20; H04N 5/91

(52) U.S. Cl. CPC G06T 19/00; G06T 15/205; H04N 5/91; G06T 2210/32

(57) ABSTRACT

A method for displaying large-format virtual reality video on a nonvirtual reality device includes identifying a location chosen by an operator comprising determining a point of interest at the location and picking a frame of action at the location to be provided in relation to the point of interest, the location is such that the point of interest and the frame of action are captured with a camera at the location, the point of interest to be accessible by a viewer in an interactive environment on a non-virtual reality device; recording a large-format video of the frame of action at the location; clarifying the large-format video into a finished large-format video file, the clarifying comprising video sorting wherein the large-format video is sorted to subsequently undergo video stitching to derive an equirectangular video, the equirectangular video then undergoing video adjusting which results in the finished large-format video file, and reframing the finished large-format video file wherein the reframing comprises manipulating the finished large-format video file into a standard aspect ratio video for displaying in the interactive environment viewable on the non-virtual reality device such that the limited viewable area is exported as a standard aspect ratio video.

### CROSS-REFERENCE TO RELATED APPLICATION(S)

This application claims the priority as a continuation-in-part of U.S. Nonprovisional patent application Ser. No. 17/854,223 (01547-BEM) filed Jun. 30, 2022 which claims the priority and benefit to U.S. Provisional Patent Application No. 63/289,090, filed Dec. 13, 2021, the contents of which are hereby incorporated by reference in its entirety. Each of the aforementioned patent applications, and any applications related thereto, are herein incorporated by reference in their entirety.

### FIELD OF TECHNOLOGY

This disclosure generally relates to methods for displaying large-format virtual reality video on a nonvirtual reality device.

### BACKGROUND

Videos and photos are useful to convey information and to educate viewers. Videos and photos may be referred to as images. Content captured in a 360-degree and/or large-format may require additional processing to be viewable by a user. For example, 360 images may be processed as monoscopic or stereoscopic images depending on the final display.

Immersive environments are simulations that allow viewers to experience a sensation similar to that of being physically present. Virtual reality, augmented reality, interactive displays, and forms of art are various examples of immersive environments. Immersive environments have been used in educational settings. As digital camera technology and processing capabilities have improved, the demand for more detailed immersive environments has increased. Though 360 cameras are long existing technologies, the industry has not been able to develop methods to allow for the simultaneous use of such videos and photos in an immersive environment.

This background section is intended to introduce the reader to various aspects of art that may be related to various aspects of the present disclosure, which are described and/or claimed below. This discussion is believed to assist the reader with background information to facilitate a better understanding of the various aspects of the present disclosure. Accordingly, it should be understood that these statements are to be read in this light, and not as admissions of prior art.

### SUMMARY

A method for displaying large-format virtual reality content on a nonvirtual reality device according to one disclosed non-limiting embodiment of the present disclosure includes identifying a location chosen by an operator comprising determining a point of interest at the location and picking a frame of action at the location to be provided in relation to the point of interest, the location is such that the point of interest and the frame of action are captured with a camera at the location, the point of interest to be accessible by a viewer in an interactive environment on a non-virtual reality device; recording a large-format content of the frame of action at the location; clarifying the large-format content into a finished large-format photo or video file, the clarifying comprising photo or video sorting wherein the large-format content is sorted to subsequently undergo stitching to derive a large-format or equirectangular photo or video, the large-format or equirectangular photo or video then undergoing adjusting which results in the finished large-format photo video file, and reframing the finished large-format photo or video file wherein the reframing comprises manipulating the finished large-format photo or video file into a standard aspect ratio photo or video for displaying in the interactive environment viewable on the non-virtual reality device such that a limited viewable area is exported as a standard aspect ratio configuration.

A further embodiment of any of the foregoing embodiments of the present disclosure includes that the reframing comprises manipulating the finished large-format photo or video file into a standard aspect ratio for displaying in the interactive environment viewable on the non-virtual reality device by manually moving a virtual camera via editing software to limit the viewable area to follow a chosen visual action such that the limited viewable area is exported as the standard aspect ratio photo or video.

A further embodiment of any of the foregoing embodiments of the present disclosure includes that the reframing comprises manipulating the finished large-format photo or video file into a standard aspect ratio for displaying in the interactive environment viewable on the non-virtual reality device is performed by an AI system such that the limited viewable area is exported as the standard aspect ratio photo or video.

A further embodiment of any of the foregoing embodiments of the present disclosure includes that a first camera is used for shooting both a large-format photos of the point of interest and used for recording the large-format video of the frame of action.

A further embodiment of any of the foregoing embodiments of the present disclosure includes that the first camera simultaneously performs shooting and recording functions.

A further embodiment of any of the foregoing embodiments of the present disclosure includes that a first camera is used for shooting the large-format photos of the point of interest at the location and a second camera is used for recording the large-format video of the frame of action at the location.

A further embodiment of any of the foregoing embodiments of the present disclosure includes that the clarifying is further comprised of organizing multiple large-format or equirectangular photo or videos into a storyboard sequence of the frame of action at the location.

A further embodiment of any of the foregoing embodiments of the present disclosure includes shooting one or more large-format photos of the point of interest at the location.

A further embodiment of any of the foregoing embodiments of the present disclosure includes that the large-format video of the frame of action provides content beyond the large-format photos of the point of interest.

A further embodiment of any of the foregoing embodiments of the present disclosure includes refining the large-format photos into a finished photo file, the refining comprising photo sorting wherein the large-format photos are sorted to subsequently undergo photo stitching to derive a large-format or equirectangular photo, the large-format or equirectangular photo adjusted to result in the finished photo file.

A further embodiment of any of the foregoing embodiments of the present disclosure includes that compiling the finished video file and the finished photo file, the finished video file and the finished photo file combined to be displayed in the interactive environment, the compiling comprising uploading, embedding, and publishing, wherein the uploading comprises uploading the finished video file and the finished photo file to a hosting server, the finished photo or video file displayed as a background to the interactive environment, wherein the embedding comprises the finished photo or video file being embedded to a particular spot on the background, wherein publishing comprises allowing the viewer access to the interactive environment.

A further embodiment of any of the foregoing embodiments of the present disclosure includes that the shooting comprises extracting a singular still image frame from the large-format content which serves as a background where the reframed, standard aspect ratio photo or video is re-inserted.

A further embodiment of any of the foregoing embodiments of the present disclosure includes compiling the finished photo or video file, wherein compiling comprises embedding, overlaying, and publishing, wherein the embedding comprises the finished photo or video file being embedded to a particular spot on a background to the interactive environment, the spot being the location of the frame of action to provide more information about content communicated in the interactive environment, wherein the overlaying comprises overlaying additional information in the interactive environment, the point of interest identifiable by the viewer interacting with the interactive environment as a selectable space of content in the interactive environment, wherein the publishing comprises allowing the viewer access to the interactive environment on the non-virtual reality device such that the interactive environment is displayed as a large-format content upon which standard aspect ratio photo or video originating from the large-format content is displayed.

A further embodiment of any of the foregoing embodiments of the present disclosure includes that a large-format file content is displayed as the background to the interactive environment, the finished photo or video file embedded to a particular spot on the background as the point of interest, the point of interest is where a viewer may interact to access the additional information.

A further embodiment of any of the foregoing embodiments of the present disclosure includes that the large-format file content is displayed as the background to the interactive environment, the finished photo or video file embedded to a particular spot on the background as the point of interest, the point of interest is selectable by a user interacting with the interactive environment.

A further embodiment of any of the foregoing embodiments of the present disclosure includes that the frame of action provides a pop-out window beyond the point of interest.

A further embodiment of any of the foregoing embodiments of the present disclosure includes that the frame of action is an area on the large-format content.

A further embodiment of any of the foregoing embodiments of the present disclosure includes that the frame of action provides text, images, or video.

A further embodiment of any of the foregoing embodiments of the present disclosure includes that the frame of action is provided in relation to the point of interest.

A further embodiment of any of the foregoing embodiments of the present disclosure includes that the point of interest is shot as a large-format photo and the frame of action is recorded as a large-format video.

A further embodiment of any of the foregoing embodiments of the present disclosure includes that the large-format video of the frame of action provides content beyond the large-format photos of the point of interest.

A further embodiment of any of the foregoing embodiments of the present disclosure includes extracting one or more large-format photos of the point of interest at the location from the large-format video of the frame of action.

A further embodiment of any of the foregoing embodiments of the present disclosure includes that photo stitching comprises combining large-format photos into a large-format or equirectangular format.

A further embodiment of any of the foregoing embodiments of the present disclosure includes that the frame of action provides a pop-out window beyond the point of interest, the frame of action is an area on the large-format photos provided in relation to the point of interest.

A further embodiment of any of the foregoing embodiments of the present disclosure includes that embedding an interactive 3D model corresponding to an object visible from the original large-format content, wherein the 3D model aligns spatially with the original camera's perspective.

A further embodiment of any of the foregoing embodiments of the present disclosure includes that the large-format content is generated entirely or partially by artificial intelligence.

A further embodiment of any of the foregoing embodiments of the present disclosure includes that one or more steps selected from sorting, stitching, adjusting, embedding, or compiling are performed automatically by artificial intelligence or software algorithms without manual intervention.

A further embodiment of any of the foregoing embodiments of the present disclosure includes that reframing comprises generating an alpha channel video configured to be transparently embedded onto a background image derived from the large-format content.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is an exemplary block diagram for a method for using one or more large-formats for displaying large-format virtual content on a nonvirtual reality device;

FIG. 2 is an exemplary block diagram showing the steps for identifying a location for recording large-format content;

FIG. 3 is an exemplary block diagram showing the steps for processing large-format content;

FIG. 4 is an exemplary block diagram showing steps for clarifying large-format content recorded at a location; and

FIG. 5 is an exemplary block diagram showing steps for compiling large-format content to an interactive environment.

### DETAILED DESCRIPTION

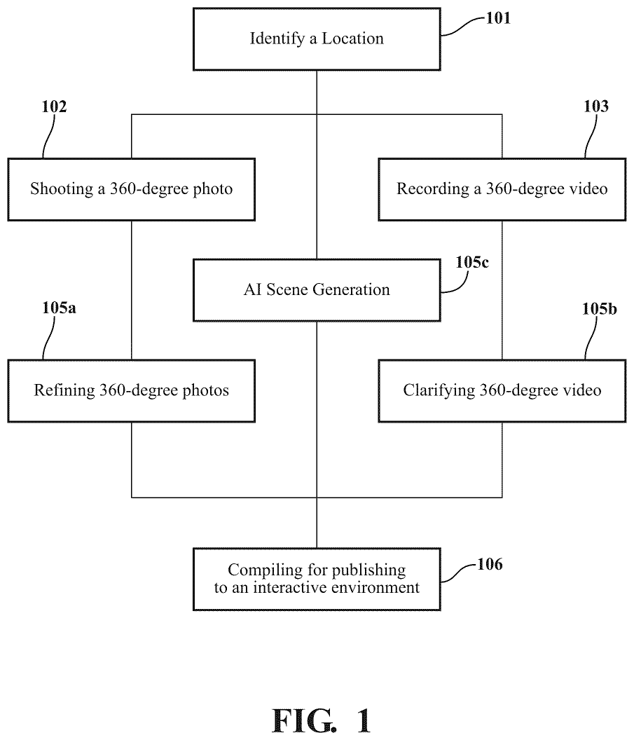

FIG. 1 is a schematic block diagram of a method for using one or more large-format sources to display an interactive environment to a viewer according to one non-limiting embodiment. This method may be referenced herein as a method for using one or more large-formats for displaying large-format virtual content on a non-virtual reality device—that may generally include identifying (step 101) a location, shooting (step 102) a large-format photo, recording (step 103) a large-format video, processing (step 105) finished files, and compiling (step 106) the finished files to an interactive environment.

As utilized herein “large-format” content may include, 180 to 360-degree photos and videos, which may encompass fully spherical, hemispherical, or partially panoramic configurations, as well as virtual reality, immersive or interactive media, and other wide-field visual formats designed to enhance the sense of spatial presence or environment. In addition, a viewer may interact with the interactive environment that is displayed. This allows an operator to use large-format cameras to shoot and record images at a location to communicate an interactive environment to a viewer. As a result, the viewer may experience a sensation similar to that of being physically present at the location. While traditional immersive environments have relied on fully spherical large-format content, other large-format types, such as 180-degree videos, 270-degree panoramic photos, and hemispherical recordings, have become increasingly popular. These large-format virtual contents require user interaction to rotate the viewable area, which can be presented on a large-format display or other interactive interface, offering a semi-immersive experience while reducing processing demands compared to the full large-format content. The disclosed method applies regardless of whether the content is fully spherical, hemispherical, or partially panoramic.

The method may include displaying the interactive environment to a viewer. The location may be at a place of work so that the interactive environment may communicate information about the place of work to a viewer. For example, the location may be at a factory or an office.

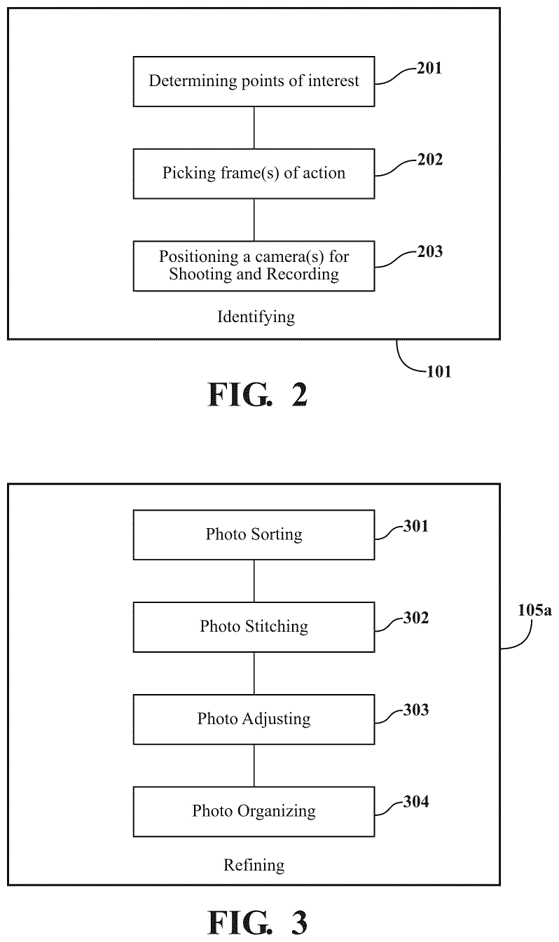

FIG. 2 is an exemplary block diagram showing the steps for identifying (step 101) a location for recording (step 103) a large-format video and shooting (step 102) a large-format photo according to one embodiment. Shooting (step 102) may include taking a large-format photo at a particular location. Recording (step 103) may include taking a large-format video at a particular location.

Identifying (step 101) a location may include determining (step 201) one or more points of interest and includes picking (step 202) one or more frames of action. For example, an operator may identify the location. The operator is someone who may physically operate the one or more cameras. A first camera may be used for shooting the large-format photos of the point of interest and a second camera may be used for recording a large-format video of the frame of action.

Alternatively, the first camera may be used for shooting both the large-format photos of the point of interest and used for recording a large-format video of the frame of action. A point of interest is an area that will ultimately be shot in a large-format photo. The point of interest may be where a viewer may interact to access additional information. A point of interest is identified as a hotspot by a user interacting with the interactive environment. Determining (step 201) a point of interest may include choosing where the large-format photo to be shot is located. Multiple points of interest may be chosen.

Alternatively, in some embodiments, the 360-degree photo and video may be generated or enhanced by artificial intelligence rather than being filmed at a real location. AI-generated 360-degree environments may be created using, for example, Neural Radiance Fields (NeRFs), which synthesize photorealistic 3D scenes based on input images; Generative Adversarial Networks (GANs), which create high-resolution 360-degree panoramas from training data; Procedural Rendering, where an AI system constructs immersive environments from algorithmically defined rules, etc. These AI-generated environments serve the same purpose as filmed environments, providing an interactive background onto which reframed videos, alpha channel videos, and 3D models may be embedded. AI-generated backgrounds behave identically to traditionally filmed backgrounds, ensuring that users experience the same level of interactivity regardless of how the environment was created. Regardless of whether the 360-degree scene is filmed or AI-generated, the process of embedding interactive content remains unchanged.

That is, AI-Based Scene Generation (step 105c) permits a large-format, e.g., 360-degree photo or video to be generated entirely by artificial intelligence rather than being filmed. The AI may use deep learning models, procedural content generation, or hybrid AI-assisted reconstruction techniques to synthesize the immersive scene. This step may replace or supplement traditional methods of filming 360-degree environments. The output of AI-Based Scene Generation (step 105c) may then proceed to the same processing steps as filmed content, including photo stitching, video reframing, and object embedding.

In other embodiments, AI Scene Customization permits artificial intelligence to autonomously modify the background environment based on external inputs or user behavior. This may include: Real-time scene updates, where the environment changes dynamically based on time of day, weather conditions, or other data; AI-generated variations, where the background adapts to different user preferences; and customizable overlays, where AI adds additional interactive elements based on context.

A hotspot or point of interest is a selectable space of content in the interactive environment. It may include the use of videos and photos within in a 360-degree immersive environment, capturing a complete object or part of the scene in all directions and using such videos and photos within in an immersive environment. The point of interest is at a location that will be accessed by viewers in the interactive environment. The frame of action may provide a pop-out window or content beyond the point of interest. The frame of action may provide text, images, videos, or allows the viewer to rotate, view, fully interact with and learn more about a given part of the interactive environment. A frame of action may be used to provide more information about content communicated in the interactive environment. For example, additional information on the day-to-day items, tools, machinery, or environment a worker is inhabiting may be provided. Picking (step 202) may include choosing a frame of action to be provided in relation to the point of interest. The location may be identified such that the frame of action(s) and the point of interest may be captured by a camera. The point of interest is being shot as a large-format photo and the frame of action may be recorded as a large-format video.

For example, suppose the method to use a camera is configured for the purpose of providing a career experience to a viewer. In that case, the hotspots may help strengthen the viewer's understanding of what the job environment provides and what prerequisites the viewer may need to succeed in a given career field. The hotspots may also help build the environment with facts about the location, the company, and the developments or practices a company may value. The operator may determine the hotspots.

A frame of action is an area at the identified location, reflecting the spot on the large-format photo where a reframed video from a large-format video or other content may be displayed. A reframed video is a large-format video that has been processed to appear as a video with a standard aspect ratio. In the disclosed method to use a camera, a reframed video is one that originated from the large-format video recorded at the identified location. The operator may pick a frame of action.

A frame of action in an interactive environment provides a select area of focus for the viewer. For example, suppose the method to use a camera is configured for the purpose of providing a career experience to a viewer. In that case, the frame of action may be a worker, product, or device. The large-format capable camera may be positioned at the location where the environment may be accurately captured. This location can be interior or exterior, as well as static/non-static. Movement is welcome across the location, as the photo and video captured depict the full environment rather than a given space area. The frame of action also determines what the viewer will be witnessing from the depicted scene.

Once determining (step 201) the point of interest and picking (step 202) frames of action has been completed, the operator may take the action of positioning (step 203) cameras for shooting (step 102) and recording (step 103). Positioning (step 203) the cameras includes placing the one or more cameras at a specific spot at the location, which allows for an appropriate distance and height from points of interest and frames of action, ensuring uninterrupted first-person view.

The type of camera which could be used for the disclosed method to use a camera may be any large-format photo or video capture device. Typically, such a device is a single device with multiple lenses allowing for everything from the camera's perspective to be captured. A large-format video capture device may be used to also shoot the large-format photo. A large-format video capture device may be a camera. A video capture device may carry out the shooting (step 102) step and the recording (step 103) step. For example, the video capture device may simultaneously perform both the shooting and recording functions. The video capture device in the example may be considered the first camera. A still-frame photo may be taken from the large-format video.

FIG. 3 is an exemplary block diagram showing the steps for refining (step 105a) a large-format photo shot at a location. Processing (step 105) a large-format photo is considered refining (step 105a). Processing (step 105) a large-format video is considered clarifying (step 105b). Refining (step 105a) and clarifying (step 105b) may collectively be referenced to as processing (step 105).

Refining (step 105a) comprises the steps of photo sorting (step 301) large-format photos that are unstitched, photo stitching (step 302) the sorted and selected photos, and adjusting (step 303) the stitched photos. Refining (step 105a) utilizes a photo sorting (step 301) function wherein large-format photos are systematically arranged to subsequently undergo photo stitching (step 302). Refining (step 105a) may further comprise photo organizing (step 304) the stitched and adjusted photos into a storyboard sequence. Photo sorting (step 301) is identifying which large-format photos or portions thereof will be used for subsequent display in the interactive environment. Multiple photos may have been shot at the location.

Photo stitching (step 302) includes combining large-format photos into a large-format or equirectangular format. The derived result of photo stitching (step 302) is a large-format or equirectangular photo. The large-format photos may be shot such that the photos are stored or saved in multiple files or formats. Photo stitching (step 302) includes the process of combining multiple photos into a panorama that may be viewable by a viewer in an interactive environment. There are many different software platforms upon which photos may undergo the photo stitching (step 302).

Refining (step 105a) utilizes photo adjusting (step 303) wherein the large-format or equirectangular photo is edited for appearance. The large-format or equirectangular photo undergoes photo adjusting which may include editing for visual adjustments, color correction, stitching errors, sharpening and denoising. Many different software platforms upon which photos may undergo the photo adjusting (step 303) are publicly available. If photo organizing (step 304) is not required, photos that have been stitched and adjusted may be converted into a finished photo file. A finished photo file is one or more resulting files that will be compiled for display in the interactive environment.

Photo organizing (step 304) the stitched and adjusted photos into a storyboard sequence is a step that is relevant when multiple stitched and adjusted photos are to be used in the interactive environment. There are many different software platforms upon which photos may undergo the photo organizing (step 304) step.

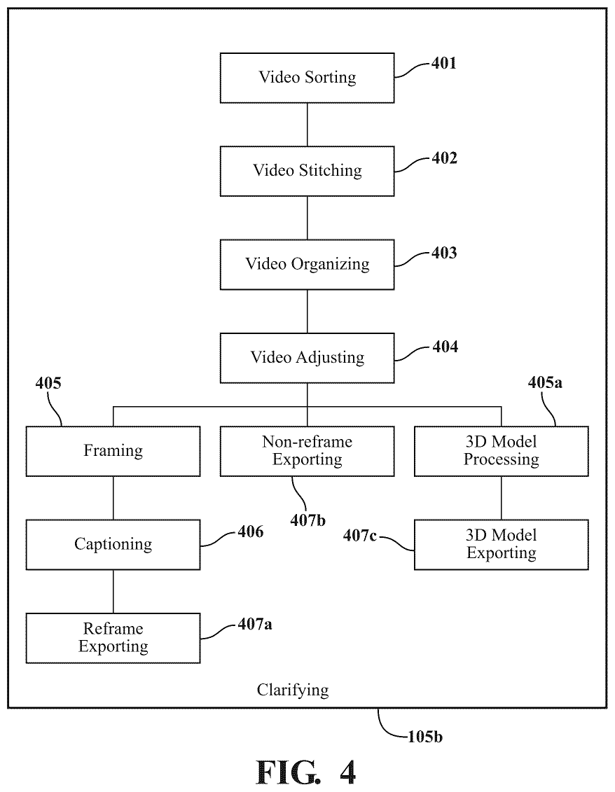

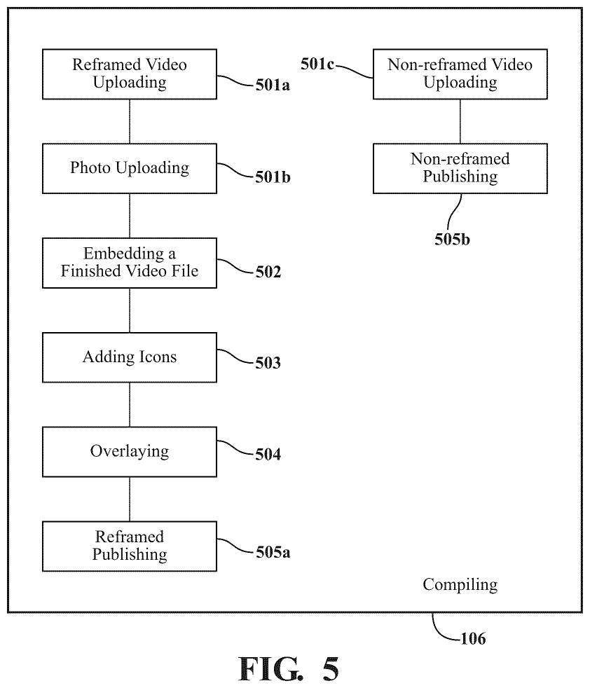

FIG. 4 is an exemplary block diagram showing the steps for processing (step 105) a large-format video recorded at a location. Processing (step 105) a large-format video may include clarifying (step 105b which may include many of the same steps as refining (step 105a). Clarifying (step 105b) may include video sorting (step 401), video stitching (step 402), and video adjusting (step 404). The clarifying (step 105b) step may include any of the following steps: video organizing (step 403), framing (step 405), captioning (step 406), or exporting (step 407) (FIG. 4).

Video sorting (step 401) is identifying which large-format videos or portions thereof, will be used for subsequent display in the interactive environment. Multiple large-format videos may have been shot at the location. Clarifying (step 105b) utilizes a video sorting (step 401) function wherein large-format videos are systematically arranged to subsequently undergo video stitching (step 402).

Video stitching (step 402) includes combining large-format videos into a large-format or equirectangular format. Video Stitching (step 402) involves combining multiple video files into an equirectangular, hemispherical, or other panoramic format, depending on the source material. This process applies to fully spherical 360-degree photos and videos as well as 180-degree, 270-degree, and hemispherical photo and video large-formats, which still require user-controlled rotation or a large-format screen, but do not provide a full wraparound experience. This process may be performed by a human operator using stitching software or fully automated using AI-based stitching algorithms that detect alignment points, correct distortions, and optimize transitions between frames. The derived result of video stitching (step 402) is a large-format or equirectangular video. The large-format videos may be recorded such that the videos are stored or saved in multiple files or formats. There are many different software platforms upon which videos may undergo the video stitching (step 402) step.

Video adjusting (step 404) the stitched videos includes editing for visual adjustments, color correction, stitching errors, sharpening, denoising, and adding a voiceover. Many different software platforms upon which videos may undergo the video adjusting (step 404) are publicly available. If video organizing (step 403) is not required, videos that have been stitched and adjusted may be converted into a finished video file. A finished video file is one or more resulting files that will be compiled for display in the interactive environment.

Video organizing (step 403) involves arranging a multiple of stitched and/or adjusted video files into a storyboard sequence. This step is relevant when multiple stitched and adjusted videos are to be used in the interactive environment. There are many different software platforms upon which videos may undergo the video organizing (step 403) step.

Framing (step 405) includes a step wherein a stitched and adjusted video is reframed to a standard aspect ratio for embedding, allowing for its placement into an interactive background. This process may be performed manually by an operator or automatically by an AI model trained to identify optimal framing based on scene composition, object detection, and motion analysis. The resulting video may be a reframed video with a fixed aspect ratio or an alpha channel video with dynamic transparency, depending on the desired effect in the interactive environment. When using an alpha channel video, background elements are removed or set to transparency, ensuring that only key subjects (such as people or objects) are displayed in the interactive environment without a rectangular video frame.

This process applies equally to reframing content from 360-degree, 180-degree, or other large-format video sources, ensuring that all panoramic content types can be embedded into an interactive environment. Video resulting from framing (step 405) may be considered a reframed video. Framing may include the process of manipulating the large-format video into a standard aspect ratio. To reframe to a standard aspect ratio only a portion of the stitched and adjusted video need be used. For example, one small portion of the large-format video may be reframed for display in the interactive environment. A portion of the large-format video may include the portion which includes a person speaking, a device, or other item which is desired to be displayed in an interactive environment. A standard aspect ratio may include, for example, a 16:9 or 4:3 ratio.

Captioning (step 406) includes captions are added to a video that has been reframed from a large-format video. For example, text could be added that provides a translation or text that provides additional information about what is being displayed in the reframed video. Captioning (step 406) is a step that is optional.

Exporting (step 407) includes the video is exported for display in an interactive environment. Exporting 407 may reference reframed exporting 407a or non-reframed exporting (step 407b). Exporting 407 may include exporting of finished files including both a finished video file and a finished photo file.

Reframed exporting (step 407a) includes the exporting of large-format video that has undergone video stitching (step 402), organizing (step 403), adjusting (step 404), framing (step 405), and optionally captioning (step 406). In addition to standard reframed videos, the method supports alpha channel video exporting, allowing transparent video layers to be overlaid onto the 360-degree background image regardless of how the background image is projected (spherical, equirectangular, flat, horizontal cross, etc.) without affecting the embedding of reframed videos, alpha channel overlays, or 3D objects. This ensures compatibility across multiple viewing platforms and display formats. This technique enhances realism by eliminating rigid borders, making the embedded video elements appear seamlessly integrated into the scene. Reframed exporting (step 407a) prepares the reframed video for integration into the interactive environment. Regardless of whether the original content was 360-degree, 180-degree, or another immersive format, the method ensures that the exported video maintains accurate alignment within the scene. The exporting process may be fully automated, where an AI system determines the best video settings, applies processing enhancements, and prepares the file for integration into the interactive environment without manual input. Multiple videos may be the result of reframed exporting (step 407a). For each frame of action there is the reframed exporting (step 407a). For example, if there are four reframed videos in a particular interactive environment, the reframed exporting (step 407a) will occur four times.

In another embodiment, instead of embedding a reframed video with a fixed aspect ratio into the interactive environment, the method supports embedding alpha channel videos with dynamic transparency. This technique removes the rigid rectangular frame typically associated with reframed videos, allowing for a more seamless integration of motion content into the static background. The result is a visually cohesive interactive experience where users can engage with embedded video elements that appear naturally within the scene, enhancing immersion while reducing visual distraction.

Non-reframed exporting (step 407b) is the exporting of large-format video that has undergone video stitching (step 402) and adjusting (step 404). The video exported in the non-reframed exporting (step 407b) is not reframed video and is referenced as non-reframed video. Non-reframed video is the video exported in non-reframed exporting (step 407b). The large-format video that has not been reframed may be exported to the interactive environment to provide additional images for the interactive environment. For example, the large-format video that has not been reframed may be uploaded in an interactive environment displayed in a virtual reality device such as a headset. The large-format video that has not been reframed may provide for a supplementary experience to the interactive environment. A virtual reality device may be a simulation providing an experience to a viewer wherein the viewer has a seemingly real or physical experience with the video. Video that is non-reframed video undergoes non-reframed video uploading (step 501c) (FIG. 5).

In another embodiment, 3D Model Processing (step 405a) includes a step wherein an object within the recorded 360-degree scene is digitally reconstructed into an interactive 3D model. The object may be scanned using various methods, including, for example, Photogrammetry (capturing multiple images and using software to reconstruct the object in 3D); LIDAR scanning (capturing depth data to create a detailed point cloud); Structured light scanning (using projected patterns to capture object geometry), etc. Once processed, the 3D model undergoes optimization for interactive display, including texture mapping, mesh simplification, and real-time rendering adjustments.

Subsequent to the 3D Model Processing 405b, the 3D Model is exported 407c into the interactive environment. The model may be windowed (displayed separately for interactive inspection) or directly overlaid onto the background photo. Direct overlaying aligns the model with its real-world location, creating the illusion of a physical object within the scene. Artificial intelligence may be used during model processing to analyze source imagery or video and assist in recreating the target object with accurate shape, scale, and positioning for effective overlay. The exported 3D model file may be in formats such as GLTF, USDZ, OBJ, or FBX to ensure broad compatibility with interactive display systems.

FIG. 5 is an exemplary block diagram showing the steps for compiling (step 106) the finished files to an interactive environment. Within the step of compiling (step 106) the finished video file resulting from clarifying (step 105b), the finished photo file resulting from refining (step 105a), and the finished file from AI-Based Scene Generation (step 105c) may be combined to be displayed in an interactive environment. A finished video file and a finished photo file may be collectively referenced as finished files. Compiling (step 106) comprises uploading (step 501), embedding (Step 502), adding (Step 503) point of interest icons, overlaying (Step 504), and publishing (step 505).

Uploading (step 501) includes reframed video uploading (step 501a), photo uploading (step 501b), and non-reframed video uploading (step 501c). A finished video file may be non-reframed video or reframed video. A finished photo file may undergo photo uploading (step 501b). Uploading 501 may include transferring finished files that resulted from refining (step 105a) and clarifying (step 105b) to a hosting server. A hosting server is a server from which a viewer may access an interactive environment. The finished photo file resulting from the refining (step 105a) may be displayed as the background of the interactive environment. Additional features, including reframed videos, viewer controls, and other features, may be overlayed.

Non-reframed video that undergoes non-reframed video uploading (step 501c) does not need to go through the steps of embedding (Step 502), adding (Step 503), and overlaying (Step 504). Non-reframed video is published to a server. Non-reframed publishing (Step 505b) is the publishing of non-reframed video. Non-reframed video, may for example, be used in a virtual reality device. Non-reframed video published for display may be considered a supplementary experience.

Embedding (Step 502) includes the function wherein a finished video file (reframed video, alpha channel video, or interactive 3D model) is attached to a spot on the photo displayed as the interactive environment's background. This applies whether the source video was captured as 360-degree, 180-degree, or other large-format immersive content that requires viewer rotation or a large-format screen to adjust the viewable area. This step may be executed by a human operator or automated by an AI system that detects optimal positioning and integrates content seamlessly based on predefined parameters.

Embedding (Step 502) includes the attachment of a finished video file to a spot on the photo displayed as the interactive environment's background. Embedding (Step 502) is the function wherein a finished video file, interactive 3D model, or AI-generated 360-degree scene is attached to the interactive environment. Whether the background is filmed or AI-generated, reframed videos, alpha channel videos, and 3D models may be seamlessly overlaid. This spot may be the location wherein an operator has selected as a frame of action. In some embodiments, an alpha channel video is embedded instead of a standard reframed video, allowing transparent video layers to be overlaid onto the background photo. This method provides a more natural and immersive experience, where reframed video content blends seamlessly with the environment without a rectangular frame. Multiple reframed videos may be attached to various spots on the photo. Multiple frames of action may be in one interactive environment. The reframed video may play when a viewer activates the reframed video. Embedding (Step 502) a reframed video in an interactive environment including a stitched large-format photo is a novel and unique concept.

For 3D models, embedding (Step 502) may involve placing an interactive object directly into the scene or within a separate viewing pane. When directly embedded, the 3D model aligns with the original camera perspective, appearing as though it is part of the environment. This method allows viewers to interact with objects naturally, rotating and zooming in to inspect them while maintaining a realistic scene composition. When windowed, the 3D model appears in a floating viewer, providing a high-resolution, fully interactive display of the object without directly modifying the 360-degree background image.

In another embodiment, instead of embedding a reframed video or photo with a fixed aspect ratio into the 360-degree photo, the method may utilize an alpha channel video. This approach allows for seamless integration of reframed content with dynamic borders, ensuring that elements within the large-format content (such as people, objects, or graphical overlays) appear naturally over the still background without a rigid rectangular frame. By embedding transparent video or photo layers, the reframed content becomes more immersive in that, only specific regions within the entire scene are made dynamic, allowing for more natural interactions within the interactive environment. These transparent layers include alpha channel data, which defines pixel-level transparency. This allows certain portions, frames, hotspots, or points of interest to appear fully opaque (e.g., a person), partially transparent (e.g., shadows or effects), or fully transparent (e.g., unused areas), blending naturally into the background. Multiple layers can be stacked or composed with varying levels of depth, creating a sense of dimensionality. For example, a foreground object may appear in front of midground motion graphics, which in turn may animate over a static 360-degree background.

In another embodiment, a 3D-scanned model of an object visible from the camera's perspective may be embedded into the interactive environment. This interactive 3D object may be generated using photogrammetry, LiDAR scanning, structured light scanning, or other 3D reconstruction techniques. Like a frame of action, the 3D model's position within the scene corresponds to the camera's original perspective, ensuring spatial accuracy.

The 3D model may be presented in, for example, two ways: as a windowed overlay, where the viewer can rotate, zoom, and inspect the object in a separate viewing pane within the interactive environment; and/or as a direct overlay, where the 3D model seamlessly integrates into the background, appearing as a natural part of the scene, similar to the alpha channel large-format process. That is, the model may be windowed for independent inspection or directly overlaid onto the background image, ensuring spatial consistency with the original scene. This facilitates enhanced user engagement, as viewers can manipulate digital objects for closer inspection rather than relying solely on pre-recorded video or static images. The embedded 3D model retains its real-world position within the interactive scene, providing a true-to-life representation of objects in the environment.

By embedding interactive 3D objects, the viewer can closely examine specific items within a scene without relying solely on pre-recorded video content. This method enhances interactivity and provides a unique way to present physical objects within a 360-degree immersive experience. The inclusion of interactive 3D models alongside reframed and alpha channel large-format content enables a more versatile and comprehensive method for presenting visual information within an immersive environment.

Adding (Step 503) points of interest icons is placing descriptive information at each point of interest selected by the operator. The added icons at the points of interest allow a viewer to be displayed additional information when an icon is clicked.

Overlaying (Step 504) includes applying additional information over the interactive environment. Large-format photos or videos (e.g., 180-degree, 270-degree) may be overlaid onto an interactive background with the same seamless integration as fully spherical 360-degree content.

Overlaying (Step 504) may include interactive 3D objects, allowing viewers to rotate, zoom, and inspect embedded models within the scene. Like reframed videos, 3D models may be seamlessly overlaid into the background using alpha transparency, ensuring they appear naturally integrated into the environment. (Step 504)

Overlaying (Step 504) may also include transparent alpha channel videos, allowing video elements to appear dynamically within the scene.

Overlaying (Step 504) may also include additional information such as navigation, virtual reality mode, instructions, and interactive interview videos. Navigation may include menu buttons, a back button, links, and other similar items. Once the images have been uploaded, videos embedded, points of interest added, and additional information overlayed, the various elements are now considered a compiled interactive environment.

Overlaying (Step 504) may also include haptic feedback, auditory cues, or other sensory elements that respond to user interactions within the immersive environment. For example: Vibration feedback when a user selects a reframed video or interacts with a 3D object; Directional audio cues that guide users to relevant embedded media; and Temperature or pressure simulation, where haptic wearables simulate environmental conditions.

Publishing (step 505) is the final step in the compiling (step 106). Publishing includes allowing viewers access to the interactive environment. The compiled interactive environment may be comprised of the uploaded finished files, the background, and the embedded content. A hosting server may be connected to one or more devices via the internet. The interactive environment may be distributed to any network-connected device for viewing. Viewers may access and interact with the environment on various platforms, including but not limited to computers, tablets, mobile devices, or head-mounted displays. As an alternative to publishing (step 505) online, the compiled interactive environment may be loaded onto local storage media for offline use. This storage media may include, for example, memory cards, external drives, or onboard device storage. In such embodiments, the media may be physically delivered and accessed for display of the interactive environment. Publishing (step 505) includes both non-reframed publishing (Step 505b) and reframed publishing (Step 505a). Reframed publishing (Step 505a) may be performed when publishing an interactive environment with finished video file as a reframed video. Non-reframed publishing (Step 505b) may be performed when publishing a non-reframed finished video file.

In embodiments, publishing (step 505) may include cross-device and cloud-based interactivity, ensuring that interactive environments can be experienced across multiple platforms, including: Standalone VR headsets, where content is displayed natively; Mobile AR/VR applications, large-format screens, immersive rooms where users access the environment on phones or tablets; and Cloud-based streaming, where users interact with embedded content through remote servers rather than processing it locally.

Reframed video that has undergone reframed video uploading (step 501a) and has gone through the steps of embedding (Step 502), adding (Step 503), and overlaying (Step 504) then undergoes reframed publishing (Step 505a). Reframed publishing (Step 505a) includes loading the compiled interactive environment to a server that viewers can access. This publishing step may be automated, where an AI system determines platform compatibility, optimizes media formats, and schedules deployment without human intervention. A hosting server may be connected to computers via the internet. The interactive environment may be distributed to any computer connected to the internet. Viewers may view the displayed interactive environment on a device.

The availability of both published non-reframed video for a supplemental experience using virtual reality, and an interactive environment including reframed video in one or more frames of action, both from the recording (step 103) of a large-format video, is a new and unique concept.

In some embodiments, any of the processing, stitching, reframing, embedding, and exporting steps described herein may be performed automatically by an AI system rather than requiring manual intervention. AI-based automation may include: Automated reframing of standard aspect ratio videos within a 360-degree background; AI-driven embedding of alpha channel videos and 3D models based on object recognition; Machine learning-based scene segmentation, where an AI agent identifies points of interest and frames of action without human input; Automated exporting and publishing, where AI optimizes media formats for various platforms. Whether the steps are performed by a human operator or an AI agent, the method remains the same, ensuring flexibility in implementation.

The interactive environment may be displayed on a variety of devices. Displaying the interactive environment is when a viewer may access the interactive environment on a device. Devices may include: smart boards, desktop computers, laptops, touch screen tablets, mobile phones, mobile phones fitted with virtual reality glasses, and wearable devices like dedicated virtual reality headsets and dedicated augmented reality headsets. Viewers may use the devices to interact with the interactive environment. For example, a viewer could use a virtual reality device to view the interactive environment. In addition, a virtual reality device could allow for the user to physically walk around, navigate the interactive environment, and activate embedded reframed videos and points of interest.

In other embodiments, the interactive environment (step 106) may provide for multi-user Interaction such that multiple viewers access and interact with the same immersive environment. User inputs (e.g., selecting embedded media, moving within the environment, or interacting with 3D models) may be synchronized across multiple devices. This step may include: Synchronized viewing sessions, where multiple users see the same scene and interactions in real-time. Collaborative annotations, where users can mark, highlight, or comment on embedded content. Multi-user object manipulation, where users can jointly interact with embedded 3D models.

In other embodiments, Adaptive Content Adjustment permits embedded videos, 3D models, and overlays to adjust dynamically based on user interaction, environment conditions, or AI-driven analysis. This step may include: AI-driven content positioning, where videos or 3D models reposition based on the user's viewing angle; Context-aware media selection, where different reframed videos or 3D objects appear based on user preferences; Real-time object recognition, where the system identifies user focus points and adjusts overlays accordingly.

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof.

Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason, the appended claims should be studied to determine true scope and content.

What is claimed is:

1. A method for displaying large-format virtual reality content on a nonvirtual reality device comprising:
identifying a location chosen by an operator comprising determining a point of interest at the location and picking a frame of action at the location to be provided in relation to the point of interest, the location is such that the point of interest and the frame of action are captured with a camera at the location, the point of interest to be accessible by a viewer in an interactive environment on a non-virtual reality device;
recording a large-format content of the frame of action at the location;
clarifying the large-format content into a finished large-format photo or video file, the clarifying comprising photo or video sorting wherein the large-format content is sorted to subsequently undergo stitching to derive a large-format or equirectangular photo or video, the large-format or equirectangular photo or video then undergoing adjusting which results in the finished large-format photo video file; and
reframing the finished large-format photo or video file wherein the reframing comprises manipulating the finished large-format photo or video file into a standard aspect ratio photo or video for displaying in the interactive environment viewable on the non-virtual reality device such that a limited viewable area is exported as a standard aspect ratio configuration.

2. The method of claim 1, wherein the reframing comprises manipulating the finished large-format photo or video file into a standard aspect ratio for displaying in the interactive environment viewable on the non-virtual reality device by manually moving a virtual camera via editing software to limit the viewable area to follow a chosen visual action such that the limited viewable area is exported as the standard aspect ratio photo or video.

3. The method of claim 1, wherein the reframing comprises manipulating the finished large-format photo or video file into a standard aspect ratio for displaying in the interactive environment viewable on the non-virtual reality device is performed by an AI system such that the limited viewable area is exported as the standard aspect ratio photo or video.

4. The method of claim 1, wherein a first camera is used for shooting both a large-format photos of the point of interest and used for recording the large format video of the frame of action.

5. The method of claim 4, wherein the first camera simultaneously performs shooting and recording functions.

6. The method of claim 4, wherein a first camera is used for shooting the large-format photos of the point of interest at the location and a second camera is used for recording the large-format video of the frame of action at the location.

7. The method of claim 1, wherein the clarifying is further comprised of organizing multiple large-format or equirectangular photos or videos into a storyboard sequence of the frame of action at the location.

8. The method of claim 1, further comprising shooting one or more large-format photos of the point of interest at the location.

9. The method of claim 8, wherein the large-format video of the frame of action provides content beyond the large-format photos of the point of interest.

10. The method of claim 9, further comprising refining the large-format photos into a finished photo file, the refining comprising photo sorting wherein the large-format photos are sorted to subsequently undergo photo stitching to derive a large-format or equirectangular photo, the large format or equirectangular photo adjusted to result in the finished photo file.

11. The method of claim 10, further comprising:
compiling the finished video file and the finished photo file, the finished video file and the finished photo file combined to be displayed in the interactive environment, the compiling comprising uploading, embedding, and publishing,
wherein the uploading comprises uploading the finished video file and the finished photo file to a hosting server, the finished photo or video file displayed as a background to the interactive environment,
wherein the embedding comprises the finished photo or video file being embedded to a particular spot on the background,
wherein publishing comprises allowing the viewer access to the interactive environment.

12. The method of claim 8, wherein the shooting comprises extracting a singular still image frame from the large-format content which serves as a background where the reframed, standard aspect ratio photo or video is re-inserted.

13. The method of claim 12, further comprising:
compiling the finished photo or video file, wherein compiling comprises embedding, overlaying, and publishing,
wherein the embedding comprises the finished photo or video file being embedded to a particular spot on a background to the interactive environment, the spot being the location of the frame of action to provide more information about content communicated in the interactive environment,
wherein the overlaying comprises overlaying additional information in the interactive environment, the point of interest identifiable by the viewer interacting with the interactive environment as a selectable space of content in the interactive environment,
wherein the publishing comprises allowing the viewer access to the interactive environment on the non-virtual reality device such that the interactive environment is displayed as a large-format content upon which standard aspect ratio photo or video originating from the large-format content is displayed.

14. The method of claim 13, wherein a large-format file content is displayed as the background to the interactive environment, the finished photo or video file embedded to a particular spot on the background as the point of interest, the point of interest is where a viewer may interact to access the additional information.

15. The method of claim 14, wherein the large-format file content is displayed as the background to the interactive environment, the finished photo or video file embedded to a particular spot on the background as the point of interest, the point of interest is selectable by a user interacting with the interactive environment.

16. The method of claim 15, wherein the frame of action provides a pop-out window beyond the point of interest.

17. The method of claim 16, wherein the frame of action is an area on the large-format content.

18. The method of claim 16, wherein the frame of action provides text, images, or video.

19. The method of claim 16, wherein the frame of action is provided in relation to the point of interest.

20. The method of claim 19, wherein the point of interest is shot as a large-format photo and the frame of action is recorded as a large-format video.

21. The method of claim 20, wherein the large-format video of the frame of action provides content beyond the large-format photos of the point of interest.

22. The method of claim 20, further comprising extracting one or more large-format photos of the point of interest at the location from the large-format video of the frame of action.

23. The method of claim 13, wherein photo stitching comprises combining large-format photos into a large-format or equirectangular format.

24. The method of claim 23, wherein the frame of action provides a pop-out window beyond the point of interest, the frame of action is an area on the large-format photos provided in relation to the point of interest.

25. The method of claim 1, further comprising embedding an interactive 3D model corresponding to an object visible from the original large-format content, wherein the 3D model aligns spatially with the original camera's perspective.

26. The method of claim 1, wherein the large-format content is generated entirely or partially by artificial intelligence.

27. The method of claim 1, wherein one or more steps selected from sorting, stitching, adjusting, embedding, or compiling are performed automatically by artificial intelligence or software algorithms without manual intervention.

28. The method of claim 1, wherein reframing comprises generating an alpha channel video configured to be transparently embedded onto a background image derived from the large-format content.
